(19) United States
(12) Patent Application Publication
(10) Pub. No.: US 2001/0037240 A1
(43) Pub. Date: Nov. 1, 2001

(54) Internet radio device and system

(76) Inventors: Michael B. Marks, South Orleans, MA (US); Joel Marks, Sherman Oaks, MA (US)

Correspondence Address: Brad I. Golstein, Metro88 Partnership, 20755 Plummer Street, Chatsworth, CA, 91311, US

(21) Appl. No.: 09/813,838

(22) Filed: Mar. 22, 2001

Related U.S. Application Data
(60) Provisional application No. 60/192,339, filed on Mar. 27, 2000.

(51) Int. Cl. G06F 17/60

(52) U.S. Cl. 705/14; 705/26; 705/400; 705/40; 455/466

(57) ABSTRACT

A method of accounting and payment for audio content played on a user device such as an Internet radio. Requested content is included in a process of message assembly where the content is divided into portions. The portions of content are attached to payment messages, where the value of a payment message and the value of its attached portion of content are similar. The payment message may be either a fee message or an advertising message. The fee message is deducted against a user account in proportion to the value of content that is delivered to the device. This account is credited by subscription payments. The advertising messages are credited to the account in lieu of subscription payments. The user may operate a selecting element of the device to opt for either of advertising or fee messages, thus choosing in real time which type of payment to use for currently playing content.

### FIELD OF THE INVENTION

The present invention concerns a device and method for receiving real time audio content and other information from the Internet in conjunction with a wireless network.

### BACKGROUND OF THE INVENTION

Information currently made available to listeners of broadcast radio is free of charge because advertising supports the cost of creating and delivering the information. An alternative model may be found with satellite radio subscription services where users pay a monthly fee to support content and can avoid some or all of the intrusion of advertising (public radio pledge drives and sponsorship announcements constitute forms of advertising). Internet radio stations derive revenue from a combination of one or more of advertising, e-commerce and subscription fees. Often the content provided free with advertising is nearly identical to the content provided for a fee. However, with all current technologies, when content is delivered with advertising, the only way a user can avoid the advertising is to change stations or turn off the radio. There is currently no method for a user to actively switch from advertising supported content to fee supported content without changing content. Likewise, there is no method for offsetting the cost of fee-supported content by accepting advertising other than changing content.

The Internet offers content that may be either freely available or available only by subscription or for a fee. Goldhaber (U.S. Pat No. 5,794,210) discloses a method for providing advertising supported content at web sites accessible by the Internet. Goldhaber's method assigns a positive value to the attention of users and a negative value to information such as advertising that a user might generally choose to avoid. Goldhaber's method rewards a user with something of positive value, possibly equal to or greater than the value of a user's attention in return for the user viewing advertising (or other similar information). In practice this may mean that a user must view a set amount of advertising before gaining free access to certain content. The method disclosed by Goldhaber also includes a means of recording a user's personal profile to enable better targeting of advertising messages. Better targeting of messages enhances the value of advertising to both the advertiser and user.

A method for providing advertising to a range of web sites from a central server is disclosed in Merriman (U.S. Pat. No. 5,948,061). Merriman discloses a system whereby an advertising server acts as a node on a network. When a user accesses a web page that is affiliated with the advertising server, the affiliated page's encoding includes an embedded reference to an object provided by the advertising server process. This causes the user's browser to contact the advertising server process to provide the advertising image or information that will appear on the accessed web page as displayed by the user's browser. Using the address information and/or other information passed by the browser for the given user (including the page being accessed by the user), the advertising server utilizes a process to determine an appropriate advertisement to select for the particular user.

The present invention utilizes communications systems that may provide asynchronous audio data derived from the Internet to a user in conjunction with wireless and wired devices. One means for transmitting data utilizes packets of data. A data stream is rendered into a series of packets before being transmitted. Each packet is transmitted over the network and then received, stored and processed at a receiving terminal such as a cellular telephone or PC where the packets may be combined and played together later or in nearly real time (perhaps with use of a buffer).

As disclosed in Bottom (U.S. Pat. No. 6,014,569), a mobile interactive radio comprises a receiver for receiving substantially continuous audio program data in the form of packets of asynchronous audio data, a converter for converting the audio data to an analog signal, and an amplifier for making audible the audio signal; it is designed to operate on a wireless network using a CDPD arrangement and may utilize a combination of audio data storage in conjunction with real time audio delivery; it may utilize identification data for determining if a user is authorized to receive audio data; it may also receive digital audio data, convert the digital audio data to an analog signal by a converter and make the analog signal audible by means of an amplifier. Bottom discloses a method in which the audio program data is received in two portions wherein, the receiver receives the second portion of the audio program data after the converter has converted the first portion of the audio program data.

Fixed or portable, the mobile interactive radio disclosed by Bottom may benefit from the use of a second sound system; Bottom provides for this possibility by means of an outlet jack that may be connected to a second acoustic system. The second sound system may be a pair of headphones, an earplug or a freestanding acoustic speaker. The possibility of using a wireless means for supplying the audio signal to an external acoustic device using a method such as an infrared data link is also disclosed.

An object of the present invention is to provide a means whereby a user may select between advertising and fee-supported wireless audio content in real time. A further object of the present invention is to provide a method for formatting wireless audio content for delivery with or without advertising in response to a user's selection. A further object of the invention is to. provide a user device for selecting and receiving wireless audio content with or without advertising.

An additional object of the present invention is to enable the interruption of pre-recorded and broadcast content by urgent or time sensitive messages delivered by means of a wireless network.

### SUMMARY OF THE INVENTION

The objects of the invention may be accomplished by the use of an Internet radio device (hereinafter, “IRD”) for wireless communication with a wireless communication system using asynchronous packet switched audio data. An IRD includes a receiver for receiving packets of asynchronous audio data, a data storage device for accumulating and combining multiple packets of audio data, a converter for converting the audio data to an analog signal, a means for sending the analog signal to an amplifier and speaker which may make the analog signal audible and a means for signaling a content provider that the content should or should not be accompanied by advertising.

In the preferred embodiment the system incorporates audio content, audio advertising, a means for combining the audio content with the advertising into a single portion of substantially continuous digital audio program data, a wireless network for transmitting the data, and an IRD for wireless communication with the wireless network.

Another aspect of the present invention is a method for receiving digital audio program data transmitted by a wireless network to an IRD. The method includes the steps of 1) receiving the program data in packets by a receiver, 2) combining and storing the data packets in complete program portions of specified lengths, 3) converting a complete program portion of data into an analog audio signal by a converter, 4) sending the analog signal to an amplifier and speaker and 5) making the analog signal audible to a user by means of an amplifier and speaker.

Another aspect of the present invention is to provide a method for transmitting audio to at least one IRD in conjunction with the Internet. The method may include the following four steps: 1) receiving identification data (hereinafter the “ID”), 2) correlating the ID with a user account stored on a computer connected to the Internet, such user account incorporating a means for automatic billing in conjunction with the ID and further containing personal profile information to enable targeting of advertising, 3) segmenting and compiling audio content with one or more advertising or fee messages to create complete portions of audio program data and 4) transmitting the complete portions of audio program data compiled at a computer connected to the internet in a digital format to the IRD.

Use of the present invention provides benefits unavailable with the prior art. The present invention enables a user to determine whether or not an audio listening experience delivered by means of a wireless network in conjunction with the Internet is provided with or without advertising interruptions.

### BRIEF DESCRIPTION OF THE DRAWINGS

FIG. 1A shows a view of the primary components of the invention in a preferred relationship to each other.

FIG. 1B shows a view of the primary components of the invention in relationship to a wireless network and the Internet.

FIG. 2A shows a preferred embodiment for an audio content provider of the present invention and its relationship to an IRD and an ad server.

FIG. 2B shows a fee message being issued from a user account.

FIG. 2C shows the message assembly process whereby ad messages are joined to portions of content and delivered to an IRD.

FIG. 3 shows an IRD interface.

### DETAILED DESCRIPTION OF THE PRESENT INVENTION

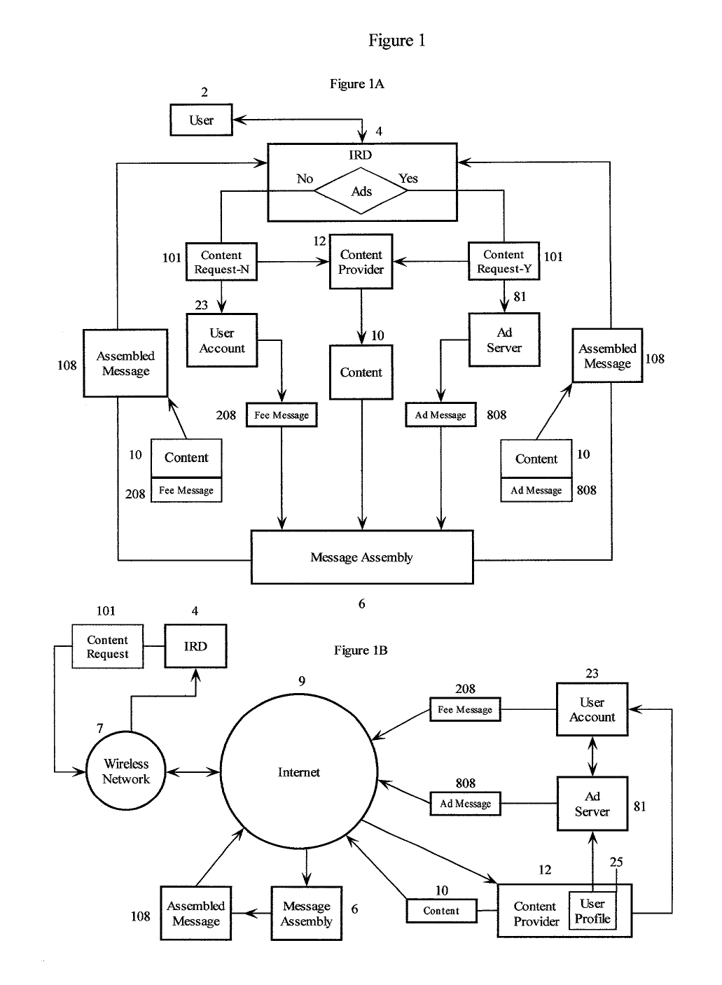

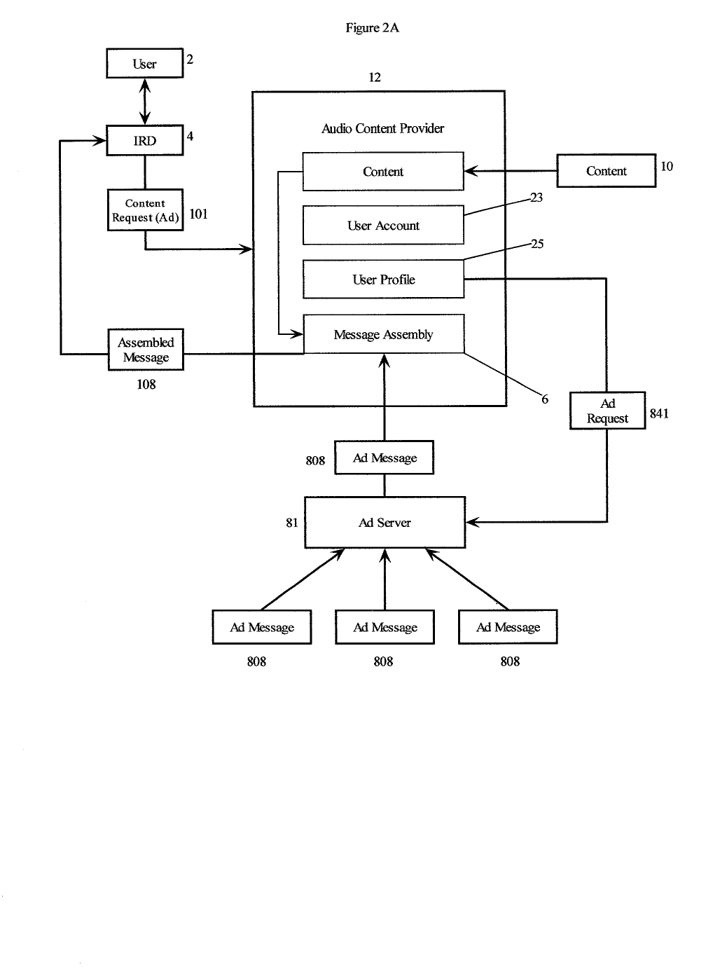

The present invention comprises a device and method for providing audio content to users. As shown in FIG. 1, the method may utilize all or parts of the system in an embodiment as follows. User 2 interfaces with the system by means of IRD 4. Content request 101 comprises a request from IRD 4 for the delivery of content 10 and incorporates a preference for content with or without an ad message; this preference is effected by a setting or adjustment made on IRD 4 by user 2. In FIG. 1A content request 101 is shown in two forms: a) Content Request-N comprising a request for content without ads and b) Content Request-Y comprising a request for content with ads. Audio content 10 comprises a complete audio program that is accessed and retrieved through content provider 12. Audio advertising 808 is accessed and retrieved through ad server 81. Content provider 12 stores user profile 25 (FIG. 1B) and shares user profile 25 with ad server 81. User profile 25 may alternatively be stored at user account 23 and shared with content provider 12 and ad server 81. Content provider 12 informs user account 23 of the cost for content 10. User account 23 records the cost. If content request 101 incorporates a request for an ad message, then user account 23 requests that one or more ad messages 808, equal to or greater in value than the cost of content 10 be sent by ad server 81 to message assembly 6. Similarly, if content request 101 incorporates a request for a fee message, then user account 23 generates fee message 208 to be sent to message assembly 6. When user account 23 sends a request for ad message 808 or generates fee message 208 it records the value of such in the account.

Prior to being sent to message assembly 6, audio content 10 is formatted into digitized packets of audio data. Likewise, if ad message 808 is an audio ad, it too is formatted into digitized packets of audio data. However, as described below, ad message 808 may comprise a text or graphics message that is sent simultaneously to a display screen on IRD 4 in conjunction with the delivery of a portion of audio content 10.

Message assembly 6 comprises a computer wherein audio content 10 is divided into portions (segments) and each portion is joined to a payment message (the payment message being either advertising message 808 or fee message 208 —fee message 208 may be itself be divided into portions). Each portion of content 10 together with the payment message creates a complete portion of program data shown as assembled message 108. A user ID matches user profile 25 to IRD 4. User profile 25 may assist in the selection of content 10 and ad message 808. Internet 9 links the components of the system together. Wireless network 7 transmits digitized packets of audio data including assembled message 108. IRD 4 receives audio data from wireless network 7.

IRD 4 incorporates a means for requesting content 10 together with a means for signaling a preference to the system for either, a) paying a fee for the content (and generating fee message 208) or, b) receiving ad message 808 in conjunction with content 10. The combined request for content 10 and preference for fee message 208 or ad message 808 comprise content request 101.

Message assembly 6 divides the complete program of content 10 into portions of program data and joins each portion to a payment message to create assembled message(s) 108. The payment message may be either ad message(s) 808 or fee message 208. The assembled messages are sent sequentially to IRD 4. When a payment message is joined to a portion of content, user account 23 records the event.

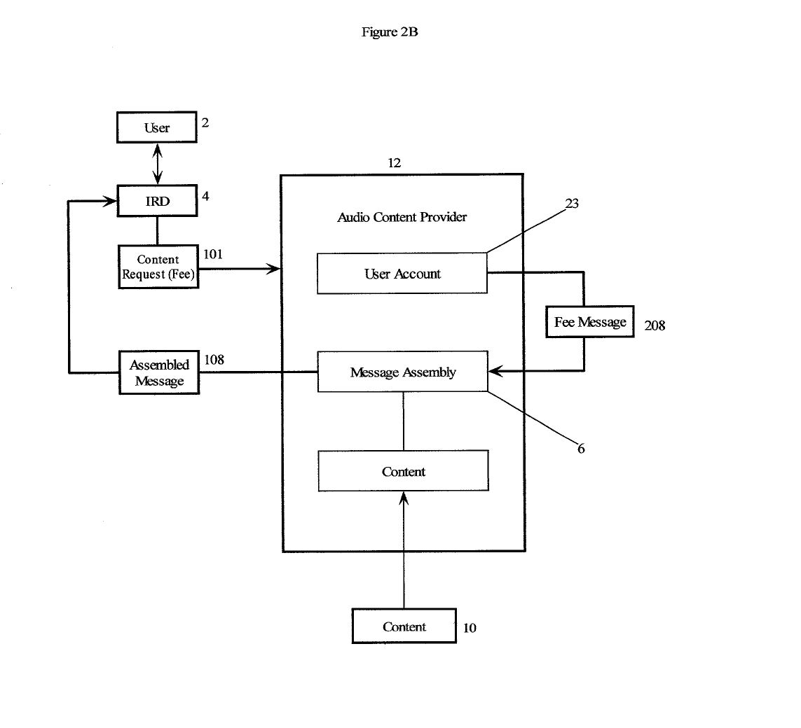

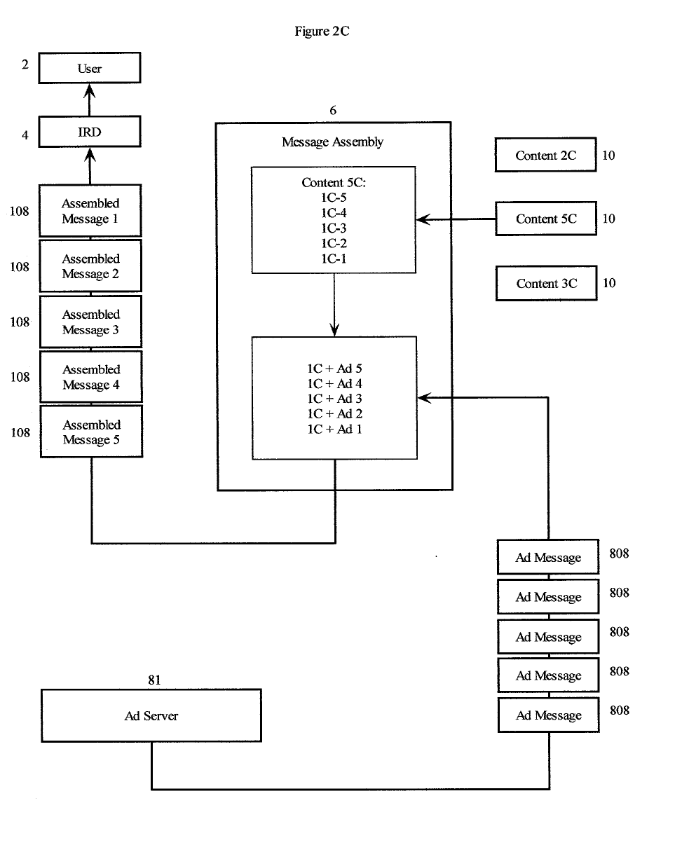

FIG. 2A shows a preferred embodiment for audio content provider 12. User 2 receives audio content 10 from audio content provider 12 by means of IRD 4. Audio content provider 12 incorporates user account 23, user profile 25 and message assembly 6 and interfaces with ad server 81. Audio content 10 may come from audio content provider 12 itself or from other sources. Audio content 10 includes any type of audible information in any format that may be communicated to audio content provider 12 and forwarded, in the form of digitized data packets, to IRD 4. Examples of audio content are music programs, talk shows, audible email messages, voice mail messages, books on tape, television audio etc. Content 10 may come from one or more web sites external to audio content provider 12. Content 10 may arrive in the form of text and subsequently be rendered into digitized audio by content provider 12, or an accessory device to IRD 4.

As shown in FIG. 1A, IRD 4 generates content request 101. As shown in FIG. 1 B, content request 101 is delivered to content provider 10 via wireless network 7 and Internet 9. Content request 101 incorporates the identity of IRD 4 and the location of content provider 12 and may further incorporate a pre-determined data message, a command that has been stored within IRD 4 and actuated by a user action such as the press of a button. An example of such a command is one that signifies, “provide a menu of options.” Content provider 12 may interpret this as a command to provide top-level subject headings such as, News, Weather, Music, Sports and so on. Upon a user's selection of a given subject heading, perhaps “Sports,” the command may be sent again, repeating, “provide a menu of options.” Now the options become sub categories of Sports: Basketball, Baseball, Football, Golf, Tennis, etc. This process could be repeated again and again until a specific event or topic is located. The request may be assigned a request code by content provider 12 and may entered into user profile 25 wherefrom subsequent requests by IRD 4 may be guided by previous request(s). The request code and identity of IRD 4 are joined to audio content 10 to effect return delivery to IRD 4.

As shown in FIG. 1B, content provider 12 invoices user account 23 for the cost of content upon receipt of content request 101. In response to such invoice, user account 23 causes a corresponding ad message 808 or fee message 208 to be sent to message assembly 6. The number of ad messages 808 is guided by the amount of the invoice such that ad server 81 seeks one or more ad messages 808 that, added together, equal in value the amount of the invoice. Likewise, fee message 208 will correspond to the amount of the invoice. Generation of fee message 208 or request for ad message(s) 808 cause credits and debits corresponding to the cost of content 10 to be entered into user account 23.

As shown in FIG. 2A, when user 2 requests content 10 with advertising (without fees). IRD 4 sends content request 101 (incorporating identification of user 2, IRD 4, content 10, preference for advertising and possibly time of day and user location) to content provider 12. Content provider 12 receives the request and a) accesses information from user profile 25, b) combines such information with other information incorporated in content request 101 to create ad request 841, c) forwards ad request 841 to ad server 81 where one or more matching advertisements are selected and, d) retrieves specified content 10. Ad server 81 delivers selected ad messages 808 to message assembly 6. Content 10 is delivered to message assembly 6 and divided into segments. Message assembly 6 joins each segment of content to an ad message 808 to form assembled messages 108. Assembled messages 108 are then sent to IRD 4.

FIG. 2B shows the process that transpires when user 2 requests content without advertising. IRD 4 sends content request 101 (incorporating identification of user 2, IRD 4, content 10 and preference for a fee) to content provider 12. Content provider 12 receives the request and a) accesses user account 23 and b) generates fee message 208 and c) retrieves specified content 10. Content 10 is delivered to message assembly 6 and divided into segments. Fee message 208 is delivered to message assembly 6. Message assembly 6 joins the segments of content 10 and fee message 208 to form assembled message 108. Assembled message 108 is then sent to IRD 4.

The integrity of the invention may be maintained regardless of the order of the steps described above so long as an assembled message is sent in response to content request. Likewise an ad request need not include profile or other ad targeting information.

In the respective embodiments of FIGS. 2A and B, user 2 may pay an advance subscription fee to audio content provider 12 to cover the cost of content and/or content delivery in conjunction with use of IRD 4. So long as user account 23 has a positive or zero balance, fee message 208 is generated automatically to accompany each portion of content 10 that is delivered to IRD 4; assembled messages 108 are delivered without ad messages 808. If user 23 carries a negative balance, such as when the fee messages have accumulated to a value greater than the current period's subscription fee, content provider 12 replaces fee message 208 with ad message(s) 808. Assembled message 108 includes ad message(s) 808 until user account 23 is restored to a positive or zero balance. In this manner user 2 may continue to enjoy uninterrupted access to content 10 regardless of account status. Content is paid for through a continuously changeable combination of advertising and fees.

Content delivered in conjunction with the present invention is divided into portions such that an ad message corresponds to the cost of a single portion, generally a fraction of the total content requested. Together, an ad message and a portion of content create a complete portion of program data. In this manner, the cost for each content portion may be fully paid for by its accompanying ad. The IRD may incorporate the option to store a complete program (multiple complete portions of ad messages or fee messages plus content) for retrieval at a later time.

FIG. 2C shows an example whereby content 10 of given length 5C is divided into five portions and each portion is joined to an ad message 808 for delivery as assembled message 108 to IRD 4. An audio content provider sends content 10 of length 5C to message assembly 6. The content provider has informed the user account of the cost for content 10. The user account has requested ads with a total value equal to this cost from ad server 81. Ad server 81 sends 5 ad messages 808 to message assembly 6. Each segment of content 10 is joined to an ad message 808 to create an assembled message 108. Assembled messages are sent sequentially to IRD 4 such that the first message received corresponds to the first portion of the program, the second message to the second portion and so on.

Message assembly 6 may format ad messages 808 and portions of content 10 in a variety of ways. Formatting may be influenced by the cost of content portions and the relative value of ad messages 808. For example, content 10 may be divided into two portions and each portion to an ad message 808. For the first portion, the ad message may be joined to back side of the content. For the second portion the ad message may be joined to the front. In this arrangement the two ad messages will play sequentially, one immediately following the other, the complete program of content 10 being divided in the middle. Alternatively, the first content portion could have the ad message in front while the second content portion had the ad message in back. In this arrangement, the complete program of content 10 would play without interruption. A user listening to a complete program (content 10 plus ad messages) may thus hear one or more advertising messages either prior to after or on both sides of the content portions. A complete program may be comprised of a single such portion. For example four ads may be combined with a single portion of program data wherein the single portion of program data comprises a complete program and the four ads play at the end of the program. Generally a complete program will be comprised of multiple portions. A long portion may be delivered without commercial interruption by increasing the length of one or two portions and providing additional ad messages at the beginning of the first portion and/or end of the second portion.

The present invention provides a means for assembling content messages of differing lengths with either advertising or fee messages. A content message of given length C may be divided into N segments of length 1/C; the revenue received by the audio content provider in conjunction with delivering an ad message is greater than or equal to the cost of delivering content segment 1/C to an IRD.

For example, a complete program may cost the audio content provider $1 to deliver (the cost of the content plus the cost of delivery) to a given user. The advertising messages available to match with the content may each generate $0.25 revenue to the audio content provider. The audio content provider wishes to earn $0.25 in revenue for each $1 of cost. Therefore, for delivering content at a cost of $1, the audio content provider seeks to receive $1.25 in revenue. Using the present invention the audio content provider may divide the content into five segments such that each segment effectively costs $0.20. Each of the content segments may then be joined with one of five advertising messages that will each earn the audio content provider $0.25.

The segments need not be of equal length to be accorded equal cost by the audio content provider. Likewise, the revenue earned from an advertising message may vary from message to message. What is significant is that the total cost of delivering a given unit of content is less than or equal to the total advertising revenue earned from ad messages delivered in conjunction with such content.

A data segment comprising a prior complete portion of program data may be received, converted into an audio signal and made audible by the IRD prior to or simultaneously with receipt of the additional segments necessary to create a complete program. Multiple complete portions of program data may be received, stored and subsequently converted into audio signals and made audible together. When a complete program is comprised of content portions accompanied by fee messages a user hears continuous audio content uninterrupted by advertising.

Advertising messages are assigned values in proportion to the fees charged to advertisers for message delivery. Fees may be charged for the length of the ad message, for the targeting information correlated to the ad message, in proportion to the bytes of data used by such message or for other features and services.

Ad messages may further or alternatively embody text and graphics ads that are displayed on a viewing screen of the IRD if the given incarnation of IRD incorporates such. In this embodiment, a complete portion of program data may include an ad message delivered to an IRD in text/graphics format

In a further embodiment, audio content may be found at one or more web sites on the Internet that may be participating in an audio network. Each web site participating in the network may share common content features such as traffic, weather and news updates that are provided by a coordinating or central web site. At the same time, each web site may provide content that is otherwise unique to it. A user accesses network web sites by selecting an IP address that has previously been stored or preset in the IRD (pre-set addresses may be overridden by the user either by means of programming functions incorporated in the IRD or by means of programming functions implemented via a computer to which the IRD is linked). In a further iteration, the addresses stored in the IRD connect to web sites with audio offerings that correspond to keywords. In this manner “golf” means a web site offering reports on a range of golfing events, and “language” means a web site offering audio language courses. The user need not know the actual address of the web sites. At the same time, the opportunity to program labels corresponding to specific web sites may be made available to the user by means of a programming function within the IRD.

As shown in FIG. 1B, ad messages 808 may be provided to the system by means of one or more ad servers 81. Content request 101 may cause ad server 81 to access user profile 25 to enable selection of ad messages 808 that best suit user 2. The selection of an appropriate ad message for user 2 may be aided by information available from wireless network 7. This information may comprise time of day and user location.

It is a key feature of the present invention that a user of the IRD may choose to receive content unaccompanied by advertising. Such a user may have previously provided a means of payment such as a credit card number to an audio content provider. Alternatively, the audio content provider may have an agreement with the wireless or other network operator whereby the fees for content delivered to the user are charged as part of the user's wireless service or Internet access charges. Regardless of how the audio content provider actually receives payment, it may be informed of a user's preference by the IRD by means of content request 101 in FIGS. 1A and B. The audio content provider may consider the preference signal to be a unique event such that subsequent transmissions of content portions are assembled in accord with a previously indicated preference. Alternatively, the preference signal may be considered a standing preference such that all subsequent transmissions of content messages are sent in accordance such preference with until the user instructs otherwise

A user listening to his IRD may hear an advertisement he finds offensive or distracting. The user may immediately terminate the playing of an advertisement message prior to completion of the full message. Such termination prior to completion causes the audio content provider to charge a fee to the user's account.

When assembled message 108 in FIGS. 1A and B incorporates fee message 208, only the content portion of the assembled message is made audible to user 2 on IRD 4. In this regard, fee message 208 may comprise a negative input to inform message assembly 6 that an ad message 808 should NOT be added to create a complete portion of program data.

When fee message 208 or advertising message 808 is joined to a portion of content 10, and the content is delivered user account 23 records the payment of a fee. Simultaneously, or in a deferred manner that allows for an accumulation of fees, payments may be paid to content providers.

An audible signal, comprising one of a voice message, a tone, or a sequence of notes, may be incorporated into assembled message 108 such that user 2 may know the value of the content being sponsored by the advertisement provider or the cost to the user of receiving the content without advertising sponsorship. The value message may also be presented in a graphics or text format on a display screen incorporated into IRD 4.

The IRD may be minimally comprised of a receiver for receiving data packets, a means for storing the data packets, a converter for converting data packets into an audio signal, and an output means for making the audio signal audible. The receiver may be any modem or like device. The means for storing the data packets may be any number of forms of memory storage devices. The converter includes any hardware and software necessary to convert the packets of audio data to an analog signal

The means for storing data packets may allow for the checking of transmission errors once the data has been stored. The correction of errors may be performed before, during or after conversion to an analog signal. The means for storing data packets may also be adjusted such that it may only send data to the converter when a complete assembled message (as in assembled message 108 in FIGS. 1A and B) is available.

The IRD incorporates a transmitter for transmitting data on the wireless network and optionally a browser for interfacing with the Internet. Data transmitted on the wireless network includes identification data, content request data and other information. Identification data may identify the specific user of the IRD and the IRD itself. In FIG. 1B, when audio content provider 12 receives content request 101 it may link IRD 4 to a web site on Internet 9 wherefrom it may receive a menu (either audibly, or perhaps as text displayed on a screen integrated into the IRD.). The items offered on the menu may include content choices such as traffic, weather, news, talk shows, sports, music and so on.

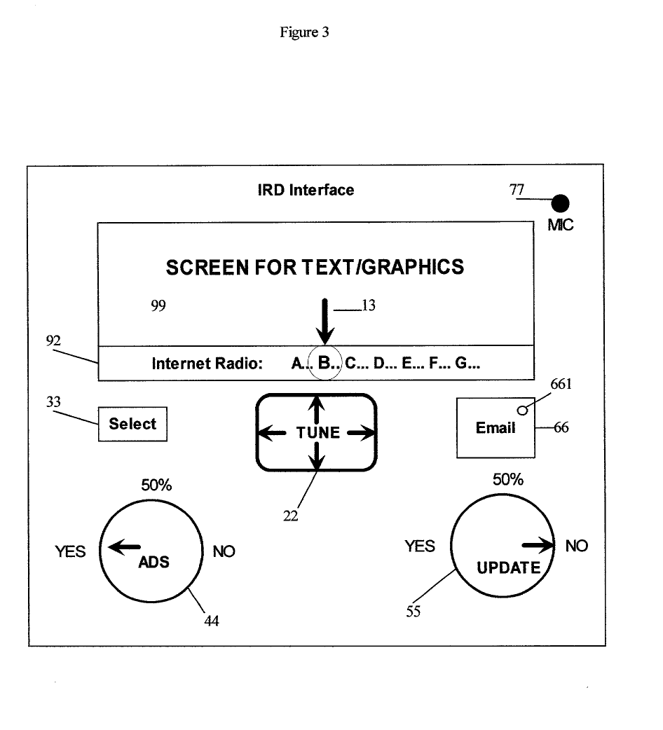

IRD 4 incorporates a user interface as shown in FIG. 3. The interface provides information and receives instructions from the user. The interface displays information such as a text/graphics menu on screen 99 and station identification bar 92. The user navigates between screen 99 and identification bar 92 and among the information elements displayed in those areas by means of tuning button 22 and display arrow 13. Information may also be presented acoustically via the audio system with which the IRD interfaces (this will be the primary method of information presentation in embodiments in which display screen 99 is not incorporated). Tuning dial 22 enables navigation and causes selections to appear on display screen 99. Display screen 99 may be touch-sensitive (in alternative embodiments virtually the entire interface may be comprised of display screen 99 wherein the screen is touch sensitive and each element is represented graphically). In another embodiment the interface may incorporate an eyeball tracking device worn by the user which may respond to blinks and other signals from the eyes; such device may be combined with voice and other input means. In addition to a means for discovering choices of audio content the user interface includes a means for selecting a given choice such as select button 33.

In the preferred embodiment the IRD interface incorporates the following components: Screen 99 displays text and graphics information including text versions of ad messages. Tuning control switch 22 moves cursor 13 causing station selections (content providers) to be highlighted. Highlighted selections may be entered by select button 33. Pressing select button 33 causes content request 101 in FIGS. 1A and B to be sent to audio content provider 12. The interface further incorporates knob 44 for signaling whether the content received on the IRD is to be accompanied by a fee message or an ad message or a combination of both. Similarly, the interface incorporates dial 55 for signaling whether or not updates should be delivered immediately, interrupting a portion of content that is being played on IRD or deferred until the portion has been completed. Setting dial 55 causes only urgent updates such as traffic situation reports to interrupt a content portion while deferring all other updates until the end of a content portion. The interface also incorporates button-indicator 66 (a button with embedded LED light) that a) tells a user when a new Email message has been received in an account maintained on his behalf at the audio content provider (the light or LED switches on in response to a signal from the provider) and b) sends a signal to retrieve Email messages when actuated by the user (such actuation extinguishes the light/LED until he next notice). Microphone 77 enables the IRD to receive voice commands; the microphone may be integral to the device, may comprise a jack in which a separate microphone device may be attached, or both.

Knob 44 enables the user to select a preference for advertising or fee-supported content. Pressing select button 33 causes content request 101 in FIGS. 1A and B to be sent to audio content provider 12. Content request 101 incorporates the preference for which knob 44 has been set. When knob 44 is set for “no ads”, content request 101 in FIGS. 1A and B causes audio content 10 to be sent from message assembly 6 as assembled messages 108 wherein each assembled message is comprised of fee message 208 plus a portion of content 10. As described above, fee message 208 may be either audible or inaudible; the audio content provider may enable the selection by the user of an audible or inaudible fee tone. When knob 44 is set for “ads”, content request 101 in FIGS. 1A and B causes audio content 10 to be sent from message assembly 6 as assembled messages 108 wherein each assembled message is comprised of an ad message 808 plus a portion of content 10. As described above, ad message 808 may be either audible, playing in conjunction with portions of content 10 or inaudible, displayed as text/graphics on the screen of the IRD.

In an alternative embodiment knob 44 may enable a user to specify that content is supported by both of advertising and fees. This may be accomplished by setting the knob 44 at predetermined ratios such as 100%, 50% and 0% such settings corresponding to 0% fees, 50% fees and 100% fees (or advertising). Upon selection of a given ratio, content request 101 in FIGS. 1A and B informs user account 23 of such ratio with each request for content. Advertising and fee messages are thereafter joined to content such that over a specified period the proportion of advertising/fee messages corresponds to the user's record.

A given ad message may be accorded a value greater than the cost of a given content portion. In such case a reverse fee message may be generated by the user account and used to supplement fees that would otherwise be charged to the user in conjunction with subsequent content delivery, thereby subsidizing the cost of a subscription.

It is a feature of the present invention that advertising and fee messages may be combined with content as a single message and made audible together; this makes it impossible to “turn off” advertising unless the user has paid a fee. In turn, this ensures that advertiser messages will be audibly (or graphically) received by the user's device unless the user actively turns off the sound (or display screen) during the advertising portion of the message or selects a content source that does not use the advertising or fee messages of the present invention.

The IRD may incorporate a battery so that it may be moved between different locations, such as between a car, office and home, to interoperate with existing audio systems without the requirement of a connection to an external power supply. Additional features may be included such as a power switch, an antenna and a means for selecting conventional FM or AM radio without use of the cellular network or the Internet.

The IRD may further comprise a system of two units: 1) a base unit, which interoperates with a wireless network and an audio system, and 2) an interface unit by which a user signals commands to the base unit. The interface unit may communicate with the base unit by means of a hard-wired link, an infrared link or a radio link.

1. A method of payment for audio content received by an Internet radio device wherein:
content is requested by a user of the device;
the requested content is included into a process of message assembly where the content is divided into portions, and a value is established for each portion of the content;
a payment message is attached to each portion of the content, the payment message representing a value at least equal to the value of each respective portion of content;
the payment message being at least one of an advertising message and a fee message;
the payment message and attached portion of content comprising an assembled message, a plurality of assembled messages being sent sequentially to the device;
a sequence of at least the portions of content being made audible to the user by the device;
a user account records a cost for a total value of the portions of content that are delivered.

2. The method of payment of claim 1 wherein the payment message is an advertising message, and the advertising message is made audible by the device.

3. The method of payment of claim 2 wherein the user receives a quantity of advertising that is in proportion to the quantity of content that is delivered to the device.

4. The method of payment of claim 1 wherein the user elects to receive advertising, the value of the user account decreases as content is delivered, value is added to the user account as each advertising message is received by the device, and the user receives advertising messages accompanying the content until the value of the user account increases to a predetermined value.

5. The method of payment of claim 1 wherein the user elects to pay a subscription fee to be entitled to receive content for a predetermined period of time, and the value of the user account increases by the amount of the fee near a time the fee is received by a service provider.

6. The method of payment of claim 5 wherein the value of content delivered to the user during the predetermined period of time exceeds a value of the subscription fee, the value of the user account decreases to below a predetermined value, and the user receives advertising messages accompanying the content until the value of the user account rises above the predetermined value.

7. The method of payment of claim 1 wherein the device includes a selecting element that determines a type of payment message that is attached to the portions of content.

8. The method of payment of claim 7 wherein the selecting element operates substantially concurrently with the delivery of content, and the user elects to incur an obligation to pay a fee in lieu of having an advertising message attached to a subsequently delivered assembled message.

9. The method of payment of claim 7 wherein the selecting element operates substantially concurrently with the delivery of content, and the user elects to receive an advertising message in lieu of incurring an obligation to pay a fee.

10. The method of payment of claim 5 wherein the fee message includes an instruction to delete an advertising message from an assembled message.

11. A method of payment for audio content received by an Internet radio device wherein:
the content is delivered by a service provider to the device;
the device includes a selecting element which determines a type of payment that is used to pay for content that is delivered to the device;
the type of payment includes at least one of advertising accompanying the content, and a fee paid to the service provider;
the selecting element operates concurrently with the delivery of content whereby the user is enabled to select the type of payment to be used for content that is delivered after the selecting element is operated.

12. The method of payment of claim 11 wherein both of advertising and a fee are used to pay for content, and the selecting element determines a relative ratio to be used for these respective types of payment.

13. The method of payment of claim 11 wherein the content is requested by a user of the device and included into a process of message assembly where the content is divided into portions, and a value is established for each portion of the content;
a payment message is attached to each portion of the content, the payment message being at least one of an advertising message and a fee message;
the payment message and attached portion of content comprising an assembled message, a plurality of assembled messages being sent sequentially to the device;
a sequence of at least the portions of content being made audible to the user by the device;
a user account records a cost for a total value of the portions of content that are delivered;
the selecting element determining which type of payment message is attached to each portion of content.

14. A method of payment for audio content received by an Internet radio device wherein:
the content is delivered by a service provider to the device;
the device includes a selecting element which determines a type of payment that is used to pay for content that is delivered to the device;
the type of payment includes at least one of advertising accompanying the content, and a fee paid to the service provider;
the delivered content is included into a process of message assembly where the content is divided into portions, and a value is established for each portion of the content;
a payment message is attached to each portion of the content, the payment message being at least one of an advertising message and a fee message;
the payment message and attached portion of content comprising an assembled message, a plurality of assembled messages being sent sequentially to the device;
a sequence of at least the portions of content being made audible to the user by the device;
a user account records a cost for a value of the portions of content that are delivered;
the selecting element determining which type of payment message is attached to each portion of content.

15. The method of payment of claim 14 wherein both of advertising and a fee are used to pay for content, and the selecting element sets a relative ratio to determine a frequency by which each of these respective types of payment are attached to the portions of content.

16. The method of payment of claim 14 wherein the fee message includes an instruction to delete an advertising message from an assembled message.

17. The method of payment of claim 14 wherein the service provider informs the user account of the value of content that is delivered.

18. The method of payment of claim 14 wherein the service provider invoices the user account for a cost of content upon receipt of the request for content, and the user account causes one of a corresponding ad message or fee message to be sent to the process of message assembly.

19. The method of payment of claim 14 wherein the assembled messages include advertising messages, a value of the user account increases as advertising messages are delivered, and the advertising messages are included in the assembled messages until the user account has increased to a predetermined value.

20. The method of payment of claim 14 wherein the type of payment is determined by the service provider when the user account has decreased to a predetermined value.
